(19) United States
(12) Patent Application Publication
(10) Pub. No.: US 2025/0072666 A1
(43) Pub. Date: Mar. 6, 2025

(54) BLADE RELEASE FOR A MICRO-PUREE MACHINE

(71) Applicant: SharkNinja Operating LLC, Needham, MA (US)

(72) Inventors: Noah Weinstock, Boston, MA (US); Connor Mayer, Norwell, MA (US)

(73) Assignee: SharkNinja Operating LLC, Needham, MA (US)

(21) Appl. No.: 18/677,580

(22) Filed: May 29, 2024

Related U.S. Application Data
(60) Provisional application No. 63/639,327, filed on Apr. 26, 2024.
(60) Provisional application No. 63/579,602, filed on Aug. 30, 2023.

(51) Int. Cl. A47J 43/07

(52) U.S. Cl. CPC A47J 43/0722; A47J 43/0727

(57) ABSTRACT

An illustrative micro-puree machine is provided. The micro-puree machine includes a detachably connectable processing container including a lid having an opening configured to receive a mixing shaft. The lid includes a blade holder configured to hold a blade assembly to the lid. The blade holder is coupled to a release lever configured to control the blade holder to be disengaged from the blade assembly when the release lever is in a release position. A base unit includes a coupling interface arranged to couple with the lid of the detachably connectable processing container. The coupling interface includes at least a portion of the mixing shaft configured to extend through the lid and into the processing container when the processing container is coupled to the coupling interface. The coupling interface includes at least one radially extending arm forming a corresponding at least one slot, each of the at least one slot including at least one sidewall.

### RELATED APPLICATIONS

This application claims priority to U.S. provisional application No. 63/639,327 filed on Apr. 26, 2024, and U.S. provisional application No. 63/579,602 filed on Aug. 30, 2023, the contents of which are included herein in their entireties.

### BACKGROUND

Domestic kitchen appliances that are intended to make ice creams, gelatos, frozen yogurts, sorbets and the like are known in the art. Typically, a user adds a series of non-frozen ingredients to a mixing bowl, which often has been previously cooled, for example, in a freezer. The ingredients are then churned by a one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are also impractical for preparing most non-dessert food products.

A type of machine known for making a frozen food product may be referred to as a micro-puree machine. Typically, machines of this nature spin and plunge a blade downward into a pre-frozen ingredient or combination of ingredients. While able to make frozen desserts like ice creams, gelatos, frozen yogurts, sorbets and the like, micro-puree machines can also prepare non-dessert types of foods such as non-dessert purees and mousses.

### SUMMARY

The application, in various implementations, addresses deficiencies associated with making and/or processing frozen food products.

This application describes illustrative systems, methods, and devices that enable a micro-puree machine to produce frozen food products such as, without limitation, ice cream in a more efficient, consistent, and user-friendly manner. In various implementations, a micro-puree machine uses a container that can be coupled to and/or mounted onto a base unit while in an inverted vertical orientation such that a bottom driven shaft can extend though an opening in a lid of the container into a cavity within the container. The mixing shaft, when extending through the lid, engages a blade assembly stored within the lid. The blade assembly includes at least one blade. The mixing shaft extends upward from the base unit into the container while also being rotated and, thereby, rotates the blade assembly so as to shave and/or mix frozen ingredients within a cavity of the container to make a frozen food product. The blade assembly couples to an end of the mixing shaft while the mixing shaft initially extends upwardly and/or inwardly into the cavity of the container as the mixing shaft rotates about a central axis until reaching about a closed end of the container. Then, the mixing shaft retracts back toward the lid and base unit. As the end of the mixing shaft passes back through the lid during retraction, the blade assembly disengages from the end of the mixing shaft and is retained within the lid. The mixing shaft then continues to retract out of the lid toward the base unit. The lid may include a blade release lever configured to engage with one of the extension arms of a drip tray. The blade release lever may rotate to open jaws of an opening on the lid to receive the mixing shaft and the blade coupling portion. The opening of the lid may align with another opening of the drip tray to receive the mixing shaft. One of the extension arms may receive the blade release lever when the lid is on drip tray.

A user is then able to decouple and/or disengage the inverted container from the base unit and flip the container to its non-inverted orientation, remove the lid, and access the processed frozen food product for consumption. One technical advantage of using an inverted container and bottom driven blade assembly to shave and/or mix frozen ingredients is that gravity can assist the shaving and/or mixing process by applying a downward pressure or force on the frozen ingredients against the upwardly extending mixing shaft and blade assembly, resulting in improved shaving and/or mixing and, ultimately, a frozen food product with an enhanced texture and/or consistency. Another technical advantage of using a bottom driven blade assembly is that the possibility of inadvertent blade assembly disengagement from the mixing shaft (e.g., blade drop) is reduced during retraction of the blade assembly because gravity asserts a downward force on the blade assembly during retraction, which assists in keeping the blade assembly coupled to the end of the mixing shaft.

According to one aspect of the subject matter described in this disclosure, an illustrative micro-puree machine is provided. The micro-puree machine includes a detachably connectable processing container including a lid having an opening configured to receive a mixing shaft. The lid includes a blade holder configured to hold a blade assembly to the lid. The blade holder is coupled to a release lever configured to control the blade holder to be disengaged from the blade assembly when the release lever is in a release position. A base unit includes a coupling interface arranged to couple with the lid of the detachably connectable processing container. The coupling interface includes at least a portion of the mixing shaft configured to extend through the lid and into the processing container when the processing container is coupled to the coupling interface. The coupling interface includes at least one radially extending arm forming a corresponding at least one slot, each of the at least one slot including at least one sidewall. The at least a first of the at least one slot is configured to receive a portion of the release lever during a coupling of the lid to the coupling interface and move the release lever to the release position.

In some implementations, the blade holder may include at least one of jaws, pins, clamps, magnets, and clasps. The coupling interface may include a drip tray, the drip tray including an opening configured to receive and allow a passing through of the mixing shaft when the mixing shaft extends from the base unit. The mixing shaft may be configured to extend through an opening in the lid. The drip tray may include an extended side wall that aligns with a portion of a circumferential wall of the coupling interface. The drip tray may include the at least one radially extending arms. The release lever may be positioned on a side of the lid that is a bottom side of the lid when coupled to the base. The at least one extension arm may include at least one sidewall configured to engage with and rotate the release lever during a coupling of the lid to the coupling interface. The blade holder may include jaws positioned to secure the blade assembly to the lid, and wherein the release lever is configured to control the jaws to release the blade assembly when the release lever is in the release position.

According to one aspect of the subject matter described in this disclosure, an illustrative base unit of a micro-puree machine is provided. The base unit includes a coupling interface arranged to couple with a lid of a detachably connectable processing container. The coupling interface includes the mixing shaft configured to extend into the processing container when the processing container is coupled to the coupling interface. The coupling interface includes a plurality of extension arms forming a corresponding plurality of slots, each of the plurality of slots including at least one sidewall. When the lid is coupled to the coupling interface, one of the plurality of slots is configured to receive a portion of a release lever while the at least one sidewall moves the release lever within the lid to a release position. The lid includes a blade holder configured to hold a blade assembly stored within the lid. The blade holder is coupled to the release lever. The release lever is configured to release the blade holder when the release lever is in the release position.

In some implementations, the coupling interface may include an opening to receive and pass through a mixing shaft extending from the base unit. The coupling interface may be positioned adjacent to the lid of the processing container when the drip tray and processing container are coupled to the coupling interface. The coupling interface may include a drain opening for receiving an overflow of food material from the reservoir. The release lever may be positioned on the bottom side of the lid. At least one of the extension arms may include the at least one side wall engaging with the release lever. The release lever may release jaws positioned at the opening to receive the mixing shaft when the release lever is activated. The base unit may further include an extended side wall, a first end of the extended side wall being coupled to the coupling interface. The base unit may further include an extended side wall, a first end of the extended side wall being coupled to the coupling interface and a pull tab coupled to a second end of the extended side wall.

According to one aspect of the subject matter described in this disclosure, an illustrative method for coupling a processing container to a micro-puree machine is provide. The method includes: providing a detachably connectable processing container with a lid having a blade holder configured to receive a mixing shaft, the blade holder configured to hold a blade assembly stored within the lid, wherein the blade holder is coupled to a release lever, the release lever configured to release the blade holder when the release lever is in a release position; providing a base unit including a coupling interface arranged to couple with the lid of the detachably connectable processing container, the coupling interface may include a portion of the mixing shaft and a drip tray; mounting the lid to a top surface of the drip tray; and extending the portion of the mixing shaft and the blade assembly into the processing container when the container is coupled to the coupling interface, the coupling interface may include a plurality of extension arms forming a corresponding plurality of slots, each of the plurality of slots including at least one sidewall.

In some implementations, the at least one side wall may engage with the lever to release jaws positioned at the opening to receive the mixing shaft when the lever is activated.

Additional features and advantages of the present disclosure is described in, and will be apparent from, the detailed description of this disclosure.

### BRIEF DESCRIPTION OF THE DRAWINGS

The disclosure is illustrated by way of example, and not by way of limitation, in the figures of the accompanying drawings in which like reference numerals are used to refer to similar elements. It is emphasized that various features may not be drawn to scale and the dimensions of various features may be arbitrarily increased or reduced for clarity of discussion.

FIG. 1A is a perspective view of an illustrative micro-puree machine configured to process frozen ingredients via a bottom driven shaft that extends through the lid of the container while the vertically inverted container is coupled to the base unit of the micro-puree machine.

FIG. 1B is an exploded view of the micro-puree machine of FIG. 1A showing the base unit, mixing container, lid, and integrated drip tray.

FIG. 1C is a perspective view of an alternative implementation of the micro-puree machine where the mixing container couples to the base unit via a coupling interface positioned horizontally closer to the front of the micro-puree machine than the back of the micro-puree machine.

FIG. 1D show side-by-side perspective views of the micro-puree machines of FIGS. 1A and 1C including showing the user interface for each of the micro-puree machines.

FIG. 2 is a cross-sectional internal view of the micro-puree machine of FIG. 1 showing a drive motor, position motor, and transmission assembly, among other internal components.

FIG. 3 shows block diagram of an illustrative controller of the micro-puree machine of FIGS. 1A and 1C.

FIGS. 4A and 4B are perspective views of the illustrative drip tray used by the micro-puree machine as shown in FIGS. 1A-2.

FIG. 4C is a top perspective view of the illustrative drip tray of the micro-puree machine of FIGS. 1A-2.

FIG. 4D is a perspective view of the illustrative drip tray while mounted and/or coupled to the base unit of the micro-puree machine of FIGS. 1A-2.

FIG. 4E is a top-down view of an embodiment of the coupling interface of the base unit and/or housing of the micro-puree machine of FIG. 1A or 1C, without the drip tray installed.

FIG. 4F is top-down view of an embodiment of the coupling interface of the base unit and/or housing of the micro-puree machine of FIG. 1A or 1C, with the drip tray installed.

FIGS. 5A and 5B are perspective views of an illustrative lid used by a micro-puree machine, such as in any of FIGS. 1A-1D and FIG. 2.

FIG. 6 is a cross-sectional view of a coupling interface used by a micro-puree machine, such as in any of FIGS. 1A-1D and FIG. 2, with a processing container, such as in any of FIGS. 1A-1D, FIG. 2, and FIGS. 5A-5B, in the coupling interface.

FIG. 7 shows a process for coupling a processing container to a micro-puree machine.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example implementations only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

In the specification and claims, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context.

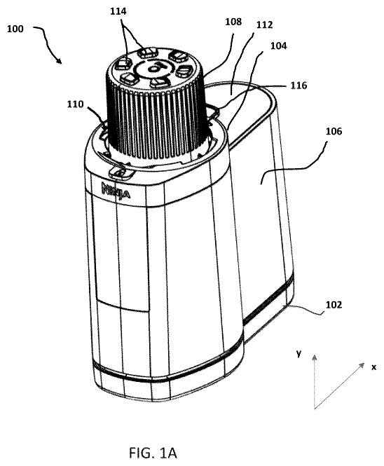

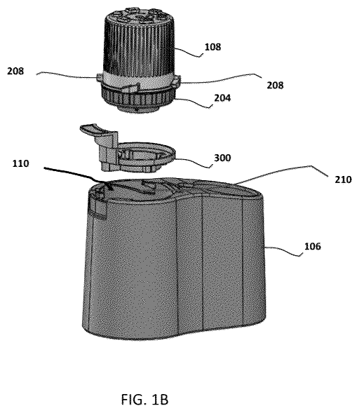

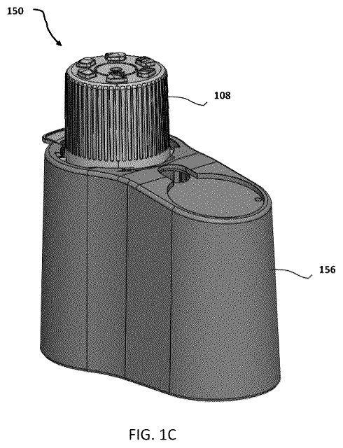

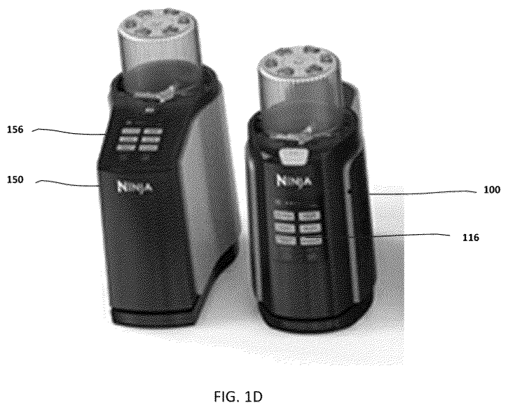

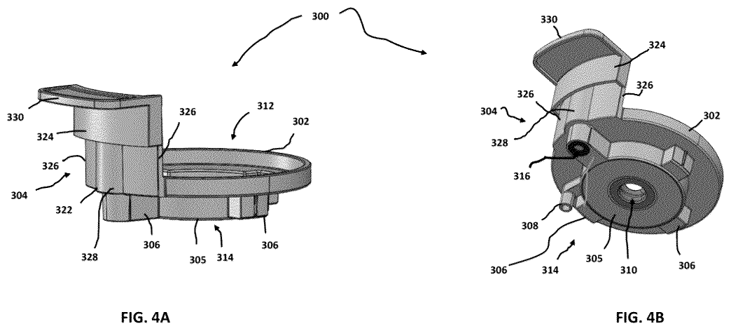

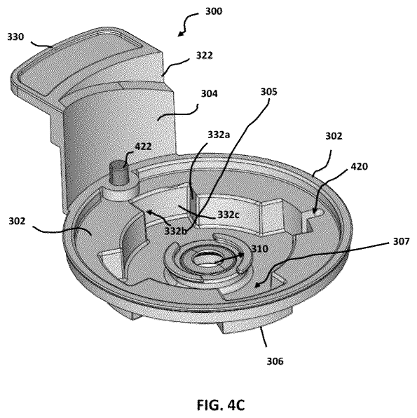

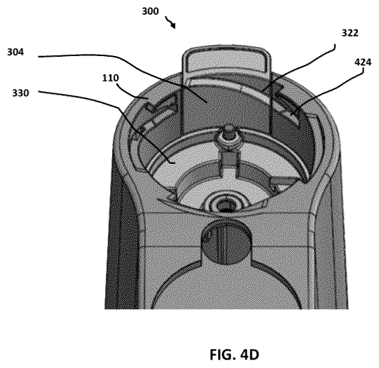

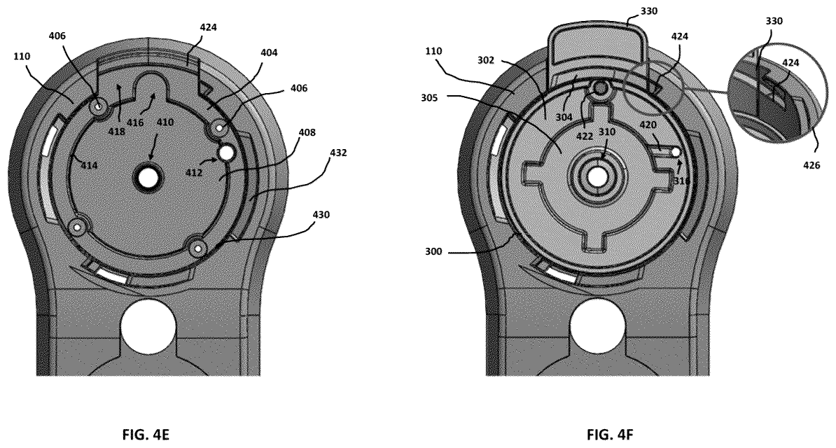

FIG. 1A is a perspective view of an illustrative micro-puree machine 100 configured to process frozen ingredients via a bottom-driven mixing shaft that extends through a lid of processing and/or mixing container 108 while the vertically inverted container 108 is coupled to the base unit and/or housing 106 at a coupling section 104 of the micro-puree machine 100. Micro-puree machine 100 may have a base section 102 to support the base unit 106. The coupling section 104 may include coupling interface 110 configured to receive an integrated drip tray 300, and include processing container 108 to enable the processing container to couple to micro-puree machine 100. The coupling section 104 may extend vertically a specified distance from the base unit 106. The drip tray, e.g., drip tray 300 of FIG. 4A, may be configured to collect food materials that may have exited or leaked from processing container 108 during food processing and/or when coupling or de-coupling container 108 to or from coupling interface 110. The food material can be any type of food or beverage, including, but not limited to frozen foods, fruit, vegetables, juices, or the like.

The processing container 108 initially may contain one or more pre-frozen ingredients for processing and/or for making a frozen food product. Container 108 may be closed using lid 204 by rotating lid 204 onto an open end of container 108 via threading, bayoneting, or another coupling technique. After closing the container 108 with the lid 204, a user may attach processing container 108 with closed lid 204 to base unit 106 via coupling interface 110 by rotating processing container 108 (and attached lid 204) relative to coupling interface 110. The processing container 108 and lid 204 may have a cylindrical or generally cylindrical shape, although other shapes may be used. The coupling interface 110 may have a larger diameter than the diameter of processing container 108 and lid 204 to accommodate coupling to the lid 204. In certain configurations, the processing container 108 with attached lid 204 is detachably connectable to coupling interface 110 using one or more bayonet tabs 208 that extend radially from container 108 and engage with one or more complementary ramped bayonet receivers 210 positioned along an inner circumference and/or wall of coupling interface 110. In some implementations, when coupling container 108 to coupling interface 110, container 108 is pressed downward and rotated such that the bayonet tabs 208 engage with corresponding ramped bayonet receivers 210 where each of the bayonet tabs 208 slide along the ramped slots of their corresponding bayonet receivers 208 until container 108 locks into and/or is coupled to coupling interface 110. The base unit 106 may vertically extend between bottom section 102 and coupling section 104. The base unit 106 may include a back portion 112 that extends horizontally beyond coupling section 104.

In some implementations, processing and/or mixing container 108 may include fixing tabs 114 on a bottom surface of the processing container 108 to aid in the fixing of frozen ingredients within the processing bowl 108. Fixing tabs 114 may prevent such ingredients from rotating within processing container 108 while the ingredients are being shaved and/or mixed by the rotating blades of a blade assembly, e.g., blade assembly 202. That is, as the food ingredients are being processed, the portion of frozen ingredients within the fixing tabs 114 may serve as a collective anchor preventing the remainder of the frozen ingredients, or a portion thereof, from rotating within the processing container as a frozen block if the rotational force of the processing overcomes the force of friction between the frozen ingredients and the side wall(s) of the processing container, which overcoming of force may be further aided by a reduction of temperature (e.g., melting) of the frozen ingredients in contact with the sidewall(s). The processing container 108 may be manufactured from and/or consist of a disposable material to enhance the convenience of using the micro-puree machine 100. In some implementations, processing container 108 can be sold as a stand-alone item and/or can also be prefilled with ingredients to be processed using micro-puree machine 100.

FIG. 1B is an exploded or unassembled view of micro-puree machine 100 of FIG. 1A showing base unit 106, mixing container 108, lid 204, and integrated drip tray 300. FIG. 1B illustrates how the drip tray 300 can be mounted onto base unit 106, and in turn the assembled mixer 108 with lid 204 can be mounted onto the drip tray 300. Furthermore, FIG. 1B illustrates how the assembled mixing container 108 with lid 204 can be dismounted and/or decoupled from drip tray 300, which in turn can be dismounted and/or decoupled from base unit 106.

FIG. 1C is a perspective view of an alternative implementation of a micro-puree machine, e.g., micro-puree machine 150, where mixing container 108 couples to the base unit 106 via a coupling interface positioned horizontally adjacent to and/or closer to the front of the micro-puree machine 150 than the back of micro-puree machine 150.

FIG. 1D shows side-by-side perspective views of the micro-puree machines 100 and 150 of FIGS. 1A and 1C including showing the user interfaces 116 and/or 362 and 156 and/or 362 for each of micro-puree machines 100 and 150.

The micro-puree machine 100 can be any type of device for processing food or beverage, including, but not limited to ice cream, slushie, or the like.

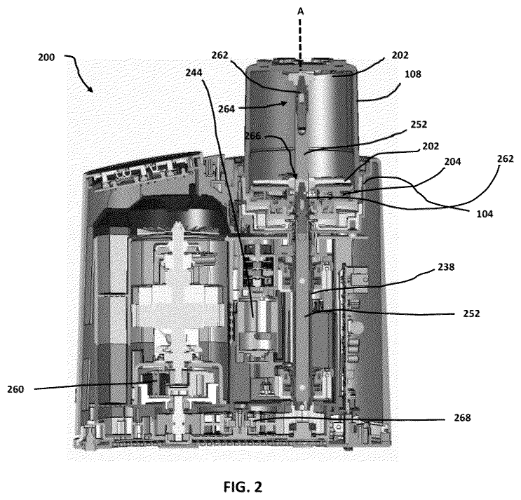

FIG. 2 is a cross-sectional view 200 of micro-puree machine 100 showing various components housed within base unit 106. The base unit 106 may include position motor 244 and drive and/or mixing motor 260. A mixing shaft 252 may couple to drive motor 260 at one end via a transmission gear assembly 268 that transfers the rotational output from drive motor 260 to rotation of mixing shaft 252 which, in turn, rotates a blade assembly, e.g., blade assembly 202, coupled to the end of mixing shaft 252. A blade coupling portion 262 may couple mixing shaft 252 to blade assembly 202 in lid 204. Different segments of blade coupling portion 262 may be positioned in lid 204 and within mixing shaft 252. Position motor 244 motor is rotated in a first direction to cause mixing shaft 252 to extend upward and/or into container 108 and in a second direction to cause mixing shaft 252 to extend downward and/or retract from container 108. This results in blade assembly 202 and blade coupling portion 262 to move in the first direction 264 extending upward and/or into container 108 and the second direction 266 extending downward and/or retract from container 108.

In some implementations, mixing shaft 252 and the inner shaft 246 may extend along a mixing shaft axis A. The mixing shaft 252 and the inner shaft 246 may be axially moveable along the mixing shaft axis A relative to a fixed outer shaft 238. One of ordinary skill recognizes that other configurations may be implemented that enable movement of mixing shaft 252 into and out of container 108 and/or along axis A. For example, mixing shaft 252 could be mounted within a housing assembly that can be moved along axis A to enable mixing shaft 252 to extend into and out of container 108. Other implementations of an extendable and retractable mixing shaft may be implemented.

In some implementations, when a user couples container 108 to base unit 106 at coupling interface 110, a blade assembly 202 that has been inserted into lid 204 attaches and/or couples to mixing shaft 252 as mixing shaft 252 extends through lid 204. The mixing and/or processing container 108 may be coupled vertically in an inverted orientation (i.e., downward) on a top or upward-facing surface of coupling interface 110. A central opening in lid 204 enables mixing shaft 252 to extended from base unit 106 into lid 204 and engage with blade assembly 202 as mixing shaft 252 moves up and then down, while rotating, to creamify, process, and/or mix ingredients in processing container 108.

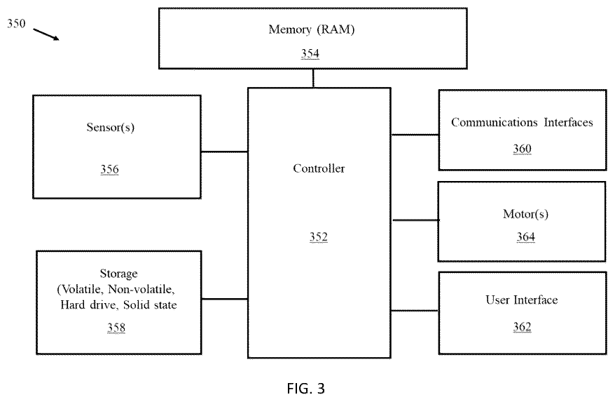

Actuation of position motor 244 and drive motor 260 may cause both rotation of mixing shaft 252 and rotation of one or more blades of blade assembly 202 about the mixing shaft 252 axis A while positioning mixing shaft 252 and the blade assembly 202 along the mixing shaft axis A to engage with ingredients inside processing container 108. The mixing shaft 252, and therefore blade assembly 202, may be controlled at different rotational speeds by controlling the speed of rotation of drive motor 260, while a speed of movement into and/or out of container 108 may be controlled by controlling a speed of rotation of position motor 244 and controlling a direction of rotation to control whether mixing shaft 252 moves inwardly or outwardly with respect to container 108. Controller 350 (FIG. 3) may control operations such as activation and deactivation of motors 244 and 260, the rate of rotation (e.g., RPM) of mixing shaft 252 and blade assembly 202, and the rate of ascent and/or descent of mixing shaft 252 and blade assembly 202 as described in more details elsewhere herein, for example, in response to different processing sequences and/or recipes to implement different processing patterns and motor speeds to make different food items and/or products.

In some implementations, micro-puree machine 100 is configured to automatically detect a size of processing container 108 and, in response to the detection, extend the blade assembly 202 a depth and/or travel distance into processing container 108 based on the detected size of processing container 108. This container-size detection enables micro-puree machine 100 to process ingredients in different sized containers, such as a single-serve container or larger containers.

FIG. 3 shows block diagram of an illustrative control system and/or controller 350 of the micro-puree machines 100 and 150 of FIGS. 1A and 1C, according to various implementations of the present disclosure. The control system 350 is not limited to implementation as part of a micro-puree machine, but can be implemented as part of other types of devices such as, for example, a blender, an ice cream maker, an immersion blender, a stand mixer, an attachment to any of such devices, or any suitable combination of such devices and/or a micro-puree machine. Control system 350 may include a microcontroller, a processor, a system-on-a-chip (SoC), a client device, and/or a physical computing device and may include hardware and/or virtual processor(s). In some implementations, control system 350 and its elements as shown in FIG. 3 each relate to physical hardware and in some implementations one, more, or all of the elements could be implemented using emulators, virtual machines or other types of executable software modules. Regardless, electronic control system 350 may be implemented on physical hardware, software, or any suitable combination thereof.

As also shown in FIG. 3, control system 350 may include a user interface 362, having, for example, a keyboard, keypad, touchpad, or sensor readout (e.g., biometric scanner) and one or more output devices, such as displays, speakers for audio, LED indicators, and/or light indicators. Control system 350 may also include communications interfaces 360, such as a network communication unit that could include a wired communication component and/or a wireless communications component, which may be communicatively coupled to controller and/or processor 352. The network communication unit may utilize any of a variety of proprietary or standardized network protocols, such as Ethernet, TCP/IP, Bluetooth, IoT, to name a few of many protocols, to effect communications between processor X02 and another device, network, or system. Network communication units may also comprise one or more transceivers that utilize the Ethernet, power line communication (PLC), Wi-Fi, cellular, and/or other communication methods.

Control system 350 may include a processing element, such as controller and/or processor 352, that contains one or more hardware processors, where each hardware processor may have a single or multiple processor cores. In one implementation, the processor 352 includes at least one shared cache that stores data (e.g., computing instructions) that are utilized by one or more other components of processor 352. For example, the shared cache may be a locally cached data stored in a memory for faster access by components of the processing elements that make up processor 352. Examples of processors include, but are not limited to a central processing unit (CPU) and/or microprocessor. Controller and/or processor 352 may utilize a computer architecture base on, without limitation, the Intel® 8051 architecture, Motorola® 68HCX, Intel® 80×86, and the like. The processor 352 may include, without limitation, an 8-bit, 12-bit, 16-bit, 32-bit, or 64-bit architecture. Although not illustrated in FIG. 3, the processing elements that make up processor 352 may also include one or more other types of hardware processing components, such as graphics processing units (GPUs), application specific integrated circuits (ASICs), field-programmable gate arrays (FPGAs), and/or digital signal processors (DSPs).

FIG. 3 illustrates that memory 354 may be operatively and communicatively coupled to processor 352. Memory 354 may be a non-transitory medium configured to store various types of data. For example, memory 354 may include one or more storage devices 358 that include a non-volatile storage device and/or volatile memory. Volatile memory, such as random-access memory (RAM), can be any suitable non-permanent storage device. The non-volatile storage devices 358 may include one or more disk drives, optical drives, solid-state drives (SSDs), tape drives, flash memory, read-only memory (ROM), and/or any other type memory designed to maintain data for a duration time after a power loss or shut down operation.

In certain configurations, the non-volatile storage devices 358 may be used to store overflow data if allocated RAM is not large enough to hold all working data. The non-volatile storage devices 358 may also be used to store programs that are loaded into the RAM when such programs are selected for execution. Data store and/or storage devices 358 may be arranged to store a plurality of food processing instruction programs associated with a plurality of food processing sequences. Such food processing and/or ice cream making instruction programs may include instruction for controller and/or processor 352 to: start or stop one or motors 364 (e.g., a mixing shaft rotation motor or position motor), operate the one or more motors 364 at certain periods during a particular food processing sequence, issue one or more cue instructions to user interface 362 that are output to a user to illicit a response, action, and/or input from the user.

Persons of ordinary skill in the art are aware that software programs may be developed, encoded, and compiled in a variety of computing languages for a variety of software platforms and/or operating systems and subsequently loaded and executed by processor 352. In one implementation, the compiling process of the software program may transform program code written in a programming language to another computer language such that the processor 352 is able to execute the programming code. For example, the compiling process of the software program may generate an executable program that provides encoded instructions (e.g., machine code instructions) for processor X02 to accomplish specific, non-generic, particular computing functions.

After the compiling process, the encoded instructions may be loaded as computer executable instructions or process steps to processor 352 from storage 358, from memory 354, and/or embedded within processor 352 (e.g., via a cache or on-board ROM). Processor 352 may be configured to execute the stored instructions or process steps in order to perform instructions or process steps to transform the electronic control system 300 into a non-generic, particular, specially programmed machine or apparatus. Stored data, e.g., data stored by a data store and/or storage device, 358 be accessed by processor 352 during the execution of computer executable instructions or process steps to instruct one or more components within control system 300 and/or other components or devices external to system 300.

User interface 362 can include a display, positional input device (such as a mouse, touchpad, touchscreen, or the like), keyboard, keypad, one or more buttons, or other forms of user input and output devices. The user interface components may be communicatively coupled to processor 352. When the user interface output device is or includes a display, the display can be implemented in various ways, including by a liquid crystal display (LCD) or a cathode-ray tube (CRT) or light emitting diode (LED) display, such as an OLED display. Sensors 356 may include one or more sensors that detect and/or monitor environmental conditions within or surrounding system 300, within or surrounding a mixing container 108, associated with drive and position motors, and/or the mixing shaft. Environmental conditions may include, without limitation, rotation, speed of rotation, and/or movement of a device or component (e.g., a motor), temperature, pressure, current, position of a device or component (e.g., extension distance of mixing shaft within container 108), and/or the presence of a device or component (e.g., whether a lid is connected to container 108). Sensors 106 may also include one or more safety and/or interlock switches that prevent or enable operation of certain components, e.g., a motor, when certain conditions are met (e.g., enabling activation of the drive and/or position motor when container coupled to the base unit). Persons of ordinary skill in the art are aware that electronic control system 300 may include other components well known in the art, such as power sources and/or analog-to-digital converters, not explicitly shown in FIG. 3.

In some implementations, control system 300 and/or processor 352 includes an SoC having multiple hardware components, including but not limited to:
a microcontroller, microprocessor or digital signal processor (DSP) core and/or multiprocessor SoCs (MPSoC) having more than one processor cores;
memory blocks including a selection of read-only memory (ROM), random access memory (RAM), electronically erasable programmable read-only memory (EEPROM) and flash memory;
timing sources including oscillators and phase-docked loops;
peripherals including counter-timers, real-time timers and power-on reset generators;
external interfaces, including industry standards such as universal serial bus (USB), FireWire, Ethernet, universal synchronous/asynchronous receiver/transmitter (USART), serial peripheral interface (SPI);
analog interfaces including analog-to-digital converters (ADCs) and digital-to-analog converters (DACs); and
voltage regulators and power management circuits.

A SoC includes both the hardware, described above, and software controlling the microcontroller, microprocessor and/or DSP cores, peripherals and interfaces. Most SoCs are developed from pre-qualified hardware blocks for the hardware elements (e.g., referred to as modules or components which represent an IP core or IP block), together with software drivers that control their operation. The above listing of hardware elements is not exhaustive. A SoC may include protocol stacks that drive industry-standard interfaces like a universal serial bus (USB).

Once the overall architecture of the SoC has been defined, individual hardware elements may be described in an abstract language called RTL which stands for register-transfer level. RTL is used to define the circuit behavior. Hardware elements are connected together in the same RTL language to create the full SoC design. In digital circuit design, RTL is a design abstraction which models a synchronous digital circuit in terms of the flow of digital signals (data) between hardware registers, and the logical operations performed on those signals. RTL abstraction is used in hardware description languages (HDLs) like Verilog and VHDL to create high-level representations of a circuit, from which lower-level representations and ultimately actual wiring can be derived. Design at the RTL level is typical practice in modern digital design. Verilog is standardized as Institute of Electrical and Electronic Engineers (IEEE) 1364 and is an HDL used to model electronic systems. Verilog is most commonly used in the design and verification of digital circuits at the RTL level of abstraction. Verilog may also be used in the verification of analog circuits and mixed-signal circuits, as well as in the design of genetic circuits. In some implementations, various components of control system X00 are implemented on a printed circuit board (PCB).

FIGS. 4A and 4B are perspective views of an illustrative drip tray 300 used by a micro-puree machine such as in any of FIGS. 1A-1D and FIG. 2. The coupling interface 110 may include a removable drip tray 300 to receive processing container 108. The drip tray 300 may be configured to collect and manage spillage and/or leakage of food material, including liquids, from lid 204 of processing container 108 during operational use and/or when mounting container 108 to coupling interface 110. A user may remove drip tray 300 from coupling interface 110 for cleaning and other purposes. In some implementations, drip tray 300 includes a food material collection reservoir and/or collector 302 and an extended sidewall 304, which extends vertically beyond other portions of the drip tray 300 in some implementations as illustrated in FIGS. 4A and 4B. The collector 302 may be designed to have a circular cross-sectional shape with a diameter larger than the cylindrical diameter of processing container 108. The collector 302 may include a front-side 312 and a back-side 314. The processing container 108 may be detachably positionable adjacent to collector 302 of drip tray 300 when drip tray 300 is coupled to coupling interface 110, e.g., drip tray 300 may be positionable below container 108 and above coupling interface 110 such that drip tray 300 is positioned in between container 108 and coupling interface 110 when container 108 is coupled to interface 110.

Moreover, collector 302 may include a lower housing 305 positioned underneath collector 302. The lower housing 305 may have a circular cross-sectional shape with several extension arms 306 extending away from the periphery of lower housing 305 and forming a slot 307 defined by sidewalls 332a, 332b, and 332c. The extension arms 306 may be used to securely position drip tray 300 within coupling interface 110. The collector 302 may include an overflow tube 308 for directing away any overflow from collector 302 if the amount of liquid and/or material captured in collector 302 exceeds its capacity. In various implementations, collector 302 includes an opening 310 at its center for receiving mixing shaft 252 and allowing mixing shaft 252 to extend into and retract out of container 108 and/or lid 204. In addition, at least one of the extension arms 306 may include an opening 316 that extends to a side (e.g., front side 312) of collector 302. The opening 316 may receive and allow the interlock button 422 to pass downward through opening 316 when pressure is applied against interlock button 422 from above, as shown in FIG. 4C and FIG. 4D.

The interlock button 422 may be biased to protrude vertically from drip try. A portion of an interlock button 422 may extend through opening 316 of lower housing 305. The interlock button 422 may detect when drip tray 300 and lid 204 have been properly mounted on and/or coupled to coupling interface 110. When properly coupled to coupling interface 110, lid 204 should push down spring-loaded interlock button 422 due to a surface of lid 204 contacting and pushing down interlock 422, which in turn may trigger a reed or other type of switch to indicate that drip tray 300 and lid 204 are mounted correctly to coupling interface 110 of micro-puree machine 100, enabling controller 352 to activate one or more components such as position and/or drive motors 364 of the micro-puree machine 100. If container 108 and/or drip tray 300 are not properly mounted on coupling interface 110, then interlock button 422 may not be depressed sufficiently to activate an interlock switch and, thereby an activation signal will not be provided to controller 352 which, in turn will not allow activation of one or more components such as position and/or drive motors 364. Moreover, the interlock button 422 may include a magnet near its bottom, so that when interlock button 422 is pushed through opening 316, interlock button 422 may actuate a reed switch in coupling interface 110 or base unit 106 that activates micro-puree machine 100.

The opening 316 may receive and allow the interlock button 422 to pass downward through opening 316 when pressure is applied against interlock button 422 from above. When processing container 108 is mounted and/or coupled to coupling interface 110, a surface of lid 204 contacts and pushes down on interlock button 422 to enable controller 352 to detect the presence of drip tray 302 and/or lid 204 and, thereby, allow position and drive motors 364 to be activated, which will be further described later herein.

The extended side wall 304 may include alignment protrusion 320. One end of extended side wall 304 may be connected to the perimeter of collector 302, while extended side wall 304 extends vertically from the collector 302. The protrusion 322 may be positioned on the perimeter of collector 302. Also, protrusion 322 may include tapered back edges 326 for self-alignment in coupling section 104. Alignment protrusion 322 may include a semi-cylindrical buttress 328 that vertically extends along protrusion 322.

The semi-cylindrical buttress 328 may provide structural support to extended side wall 304. Moreover, semi-cylindrical buttress 328 may be positioned between tapered back edges 326. Top section 324 may laterally extend a portion of extended side wall 304 above protrusion 322. Also, top section 324 may provide a clean visual and user accessible touch point. A pull tab 330 may be positioned adjacent to top section 324 on one end of extended side wall 304. The configuration of extended side wall 304 and pull tab 330 may allow a user to efficiently release, dismount, and/or decouple drip tray 300 from coupling interface 110 by pulling the pull tab 330 vertically after the removal of processing container 108. The configuration of extended side wall 304 and pull tab 330 may also allow a user to more efficiently attach, mount, and/or couple drip tray 300 to coupling interface 110.

FIGS. 4E-4F are top-down views of coupling interface 110 with and without drip tray 300 installed. FIG. 4E shows coupling interface 110 without drip tray 300. In this configuration, coupling interface 110 may include an elevated surface 404 with a substantially circular shape. Several connector posts 406 may be positioned at various locations on elevated surface 404 to fasten elevated surface 404 to base unit 106 (e.g., during assembly of a micro-puree machine). The coupling interface 110 may include a bottom surface 408 having an opening 410 through which mixing shaft 252 may extend toward container 108 and/or lid 204 when mounted on coupling interface 108 or may retract toward base unit 106. Also, the bottom surface 408 may include an opening 412 that may be coupled to drain tube 308 to enable overflow drainage of collected liquid and/or food material from drip tray 300. A lower sidewall 414 may be positioned on the outer periphery of elevated surface 402. An upper circumferential sidewall 430 of the coupling interface 110 may include multiple ramped bayonet receivers such as bayonet receivers 432 spaced apart along the sidewall 430. An indented and/or notched portion 416 of elevated surface 402 may receive one of the arms 306 of lower housing 305 to align drip tray 300 within coupling interface 110. A cut-out portion 418 of sidewall 414 may receive extended side wall 304.

FIG. 4F shows the coupling interface 110 with drip tray 300 coupled and/or mounted to coupling interface 110. The periphery of collector 302 may be positioned on elevated surface 402. The lower housing 305 may be positioned on and/or adjacent to bottom surface 408. In this configuration, opening 310 may be aligned with opening 410 of coupling interrace 110, allowing processing container 108 to receive mixing shaft 252 when being extended from base unit 106. Opening 316 may be the opening of a drain tube that passes through opening 412 to remove the overflow from processing container 108. A channel 420 may be used to direct the overflow to opening 308 and ultimately opening 412 for removal.

The extended side wall 304 may be mounted within and/or aligned adjacent to cut-out region 418. In some implementations, pull tab 330 extends horizontally outward beyond coupling section 104 and/or coupling interface 110. A first bayonet receiver portion 424, positioned in cut-out portion 418, may align with a second bayonet receiver portion 322 positioned on extended side wall 304 of drip tray 300 such that, when drip tray 300 is coupled to coupling interface 110, the first bayonet receiver portion 424 and second bayonet receiver portion 322 align to form a complete and/or singular ramped bayonet receiver, e.g., a bayonet receiver 210, configured to receive a bayonet tab 208 of container 108 to enable drip tray 300 and container 108 to be coupled and/or mounted in a secure manner to coupling interface 110.

FIG. 4F is a perspective view of illustrative drip tray 300 while mounted and/or coupled to the coupling interface 110 of base unit 106 of the micro-puree machine 100. FIG. 4F illustrates how first bayonet receiver portion 424, positioned in cut-out portion 418, is aligned with second bayonet receiver portion 322 positioned on extended side wall 304 of drip tray 300 such that, when drip tray 300 is coupled to coupling interface 110, first bayonet receiver portion 424 and second bayonet receiver portion 322 align to form a singular ramped bayonet receiver, e.g., a bayonet receiver 210, configured to receive a bayonet tab 208 of container 108 to enable drip tray 300 and container 108 to be coupled and/or mounted in a secure manner to coupling interface 110.

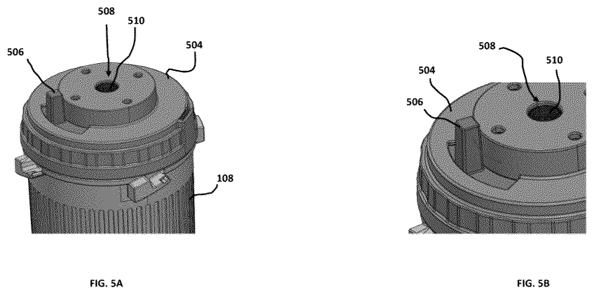

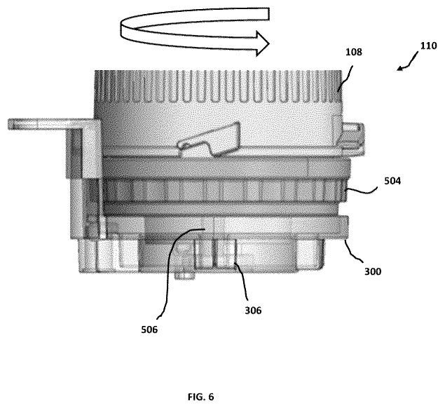

FIGS. 5A and 5B are perspective views of an illustrative lid 500 used by a micro-puree machine, such as in any of FIGS. 1A-1D and FIG. 2. Container 108 may be closed using lid 504 by rotating lid 504 onto an open end of container 108 via threading, bayoneting, or another coupling technique, as shown in FIG. 5A. After closing container 108 with lid 504, a user may attach processing container 108 with closed lid 504 to the base unit 106 via coupling interface 110 by rotating processing container 108 (and attached lid 504) relative to coupling interface 110. The coupling interface 110 may have a larger diameter than the diameter of the processing container 108 and lid 504 to accommodate coupling to lid 504. Moreover, the coupling interface 110 may include a drip tray with 300 positioned within.

Lid 504 further includes a blade release lever 506 configured to engage with one of the extension arms 306 of drip tray 300. Each extension arm 306 may form a slot 507 facing away from drip tray 300 and toward a processing container when the processing container is coupled to drip tray 300 and/or coupling interface 110. Drip tray 300 includes a number of extension arms 306 positioned on its collector 302, as shown in FIGS. 4A-4F, forming corresponding slots 507 facing a toward a processing container. As shown in FIG. 5B, the blade release lever 506 may rotate to open jaws 510 of blade holder 508 to receive mixing shaft 252 and blade coupling portion 262. Opening 310 may align with blade holder 508 of drip tray 300 to receive mixing shaft 252. One of the slots 307 of one of the extension arms 306 may receive blade release lever 506 when lid 504 is on and/or coupled to coupling interface 110 and/or drip tray 300. Container 108 may be rotated to lock coupling interface 110 with container 108, leading to one of the sidewalls of a slot 307 of an extension arms 306 contacting, pushing, and/or engaging blade release lever 506, causing release lever 506 to rotate to its release position which, in turn, opens jaws 510 of blade holder 508 to receive mixing shaft 252 and blade coupling portion 262. The release lever 506 may be a spring actuated lever or the like configured to return to its original non-release position when no force is applied to the release lever.

FIG. 6 is a cross-sectional view of a coupling interface 110 used by a micro-puree machine, such as in any of FIGS. 1A-1D and FIG. 2, with a processing container 108, such as in any of FIGS. 1A-1D, FIG. 2, and FIGS. 5A-5B, coupled to the coupling interface 110. The processing container 108 may include lid 504 positioned on and/or coupled to drip tray 300 and/or coupling interface 110. In some implementations, coupling interface 110 may not include a drip tray and processing container 108 is configured to couple to coupling interface 110. One of the slots 307 of extension arms 306 may receive lever 506. Once the processing container 108 is positioned on and/or coupled to coupling interface 110, including positioning release lever 506 within a slot 307 of an extension arm 306, a user may rotate processing container 108, e.g., in a clockwise direction, causing release lever 506 to engage with a sidewall of extension arm 306 within slot 307 and, thereby rotate release lever 506 from its non-release or lock position to its release position. When in the release position, release lever 506 releases the jaws 510 of blade holder 508 (FIGS. 5A-5B) to allow blade holder 508 to receive mixing shaft 252 and blade coupling portion 262. If extension lever 506 is not properly placed in one of the slots 307 of extension arms 306, release lever 506 may not be able to engage with a sidewall of a slot 307 and, therefore, not be able to properly rotate to the release position and activate or open jaws 510, preventing jaws 510 from receiving mixing shaft 252 and blade coupling portion 262.

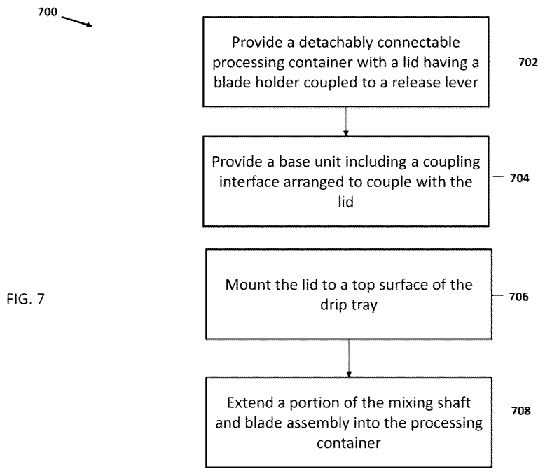

FIG. 7 shows a process 700 for coupling a processing container, such as processing container 108, to a micro-puree machine, such as micro-puree 100. Process 700 includes: providing a detachably connectable processing container with a lid having a blade holder configured to receive a mixing shaft (Step 702), the blade holder may be configured to hold a blade assembly stored within the lid, the blade holder may be coupled to a release lever, the release lever may be configured to release the blade holder when the release lever is in a release position; providing a base unit including a coupling interface arranged to couple with the lid of the detachably connectable processing container (Step 704), the coupling interface may include a portion of the mixing shaft and a drip tray; mounting the lid to a top surface of the drip tray (Step 706); and extending the portion of the mixing shaft and the blade assembly into the processing container when the container is coupled to the coupling interface (Step 708), the coupling interface may include a plurality of extension arms forming a corresponding plurality of slots, each of the plurality of slots including at least one sidewall.

Reference in the specification to “one implementation” or “an implementation” means that a particular feature, structure, or characteristic described in connection with the implementation is included in at least one implementation of the disclosure. The appearances of the phrase “in one implementation,” “in some implementations,” “in one instance,” “in some instances,” “in one case,” “in some cases,” “in one embodiment,” or “in some embodiments” in various places in the specification are not necessarily all referring to the same implementation or embodiment.

Finally, the above descriptions of the implementations of the present disclosure have been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Accordingly, the present disclosure is intended to be illustrative, but not limiting, of the scope of the present disclosure, which is set forth in the following claims.

What is claimed is:

1. A micro-puree machine comprising:
a detachably connectable processing container including a lid having an opening configured to receive a mixing shaft, the lid including a blade holder configured to hold a blade assembly to the lid, the blade holder being coupled to a release lever configured to control the blade holder to be disengaged from the blade assembly when the release lever is in a release position; and
a base unit including a coupling interface arranged to couple with the lid of the detachably connectable processing container, the coupling interface including at least a portion of the mixing shaft configured to extend through the lid and into the processing container when the processing container is coupled to the coupling interface, the coupling interface including at least one radially extending arm forming a corresponding at least one slot, each of the at least one slot including at least one sidewall; wherein at least a first of the at least one slot is configured to receive a portion of the release lever during a coupling of the lid to the coupling interface and move the release lever to the release position.

2. The micro-puree machine of claim 1, wherein the blade holder includes at least one of jaws, pins, clamps, magnets, and clasps.

3. The micro-puree machine of claim 1, wherein the coupling interface includes a drip tray, the drip tray including an opening configured to receive and allow a passing through of the mixing shaft when the mixing shaft extends from the base unit.

4. The micro-puree machine of claim 3, wherein the mixing shaft is configured to extend through an opening in the lid.

5. The micro-puree machine of claim 3, wherein the drip tray includes an extended side wall that aligns with a portion of a circumferential wall of the coupling interface.

6. The micro-puree machine of claim 1, wherein the drip tray includes the at least one radially extending arms

7. The micro-puree machine of claim 1, wherein the release lever is positioned on a side of the lid that is a bottom side of the lid when coupled to the base.

8. The micro-puree machine of claim 7, wherein the at least one extension arm includes at least one sidewall configured to engage with and rotate the release lever during a coupling of the lid to the coupling interface.

9. The micro-puree machine of claim 1, wherein the blade holder including jaws positioned to secure the blade assembly to the lid, and wherein the release lever is configured to control the jaws to release the blade assembly when the release lever is in the release position.

10. A base unit of a micro-puree machine comprising:
a coupling interface arranged to couple with a lid of a detachably connectable processing container, the coupling interface including the mixing shaft configured to extend into the processing container when the processing container is coupled to the coupling interface, the coupling interface including a plurality of extension arms forming a corresponding plurality of slots, each of the plurality of slots including at least one sidewall;
wherein when the lid is coupled to the coupling interface, one of the plurality of slots is configured to receive a portion of a release lever while the at least one sidewall moves the release lever within the lid to a release position, the lid including a blade holder configured to hold a blade assembly stored within the lid, the blade holder being coupled to the release lever, the release lever being configured to release the blade holder when the release lever is in the release position.

11. The base unit of claim 10, wherein the coupling interface includes an opening to receive and pass through a mixing shaft extending from the base unit.

12. The base unit of claim 11, wherein the coupling interface is positioned adjacent to the lid of the processing container when the drip tray and processing container are coupled to the coupling interface.

13. The base unit of claim 10, wherein the coupling interface includes a drain opening for receiving an overflow of food material from the reservoir.

14. The base unit of claim 10, wherein the release lever is positioned on the bottom side of the lid.

15. The base unit of claim 14, wherein at least one of the extension arms includes the at least one side wall engaging with the release lever.

16. The base unit of claim 10, wherein the release lever releases jaws positioned at the opening to receive the mixing shaft when the release lever is activated.

17. The base unit of claim 10, further comprising an extended side wall, a first end of the extended side wall being coupled to the coupling interface.

18. The base unit of claim 17, further comprising an extended side wall, a first end of the extended side wall being coupled to the coupling interface and a pull tab coupled to a second end of the extended side wall.

19. A method for coupling a processing container to a micro-puree machine comprising:
providing a detachably connectable processing container with a lid having a blade holder configured to receive a mixing shaft, the blade holder configured to hold a blade assembly stored within the lid, wherein the blade holder is coupled to a release lever, the release lever configured to release the blade holder when the release lever is in a release position;
providing a base unit including a coupling interface arranged to couple with the lid of the detachably connectable processing container, the coupling interface including a portion of the mixing shaft and a drip tray;
mounting the lid to a top surface of the drip tray; and
extending the portion of the mixing shaft and the blade assembly into the processing container when the container is coupled to the coupling interface, the coupling interface including a plurality of extension arms forming a corresponding plurality of slots, each of the plurality of slots including at least one sidewall.

20. The method of claim 19, wherein the at least one side wall engages with the lever to release jaws positioned at the opening to receive the mixing shaft when the lever is activated.
